(19) United States
(12) Patent Application Publication
(10) Pub. No.: US 2015/0302876 A1
(43) Pub. Date: Oct. 22, 2015

(54) DATA STORAGE APPARATUS AND METHOD FOR CORRECTING REPEATABLE RUNOUT

(71) Applicant: KABUSHIKI KAISHA TOSHIBA, Tokyo (JP)

(72) Inventors: Kazuto Kashiwagi, Yokohama (JP); Takeyori Hara, Kawasaki (JP); Takayuki Kawabe, Sagamihara (JP)

(21) Appl. No.: 14/475,833

(22) Filed: Sep. 3, 2014

Related U.S. Application Data
(60) Provisional application No. 61/981,100, filed on Apr. 17, 2014.

(51) Int. Cl. G11B 5/596

(52) U.S. Cl. CPC G11B 5/59627

(57) ABSTRACT

According to one embodiment, a data storage apparatus includes a disk configured to be recorded correction information corresponding to radial positions of the disk and variation information corresponding to the correction information, each of the correction information being information for correcting a repeatable runout, and each of the variation information being information corresponding to a variation amount of a repeatable runout, and a controller configured to correct a first repeatable runout at a first radial position by using a first correction information and a first variation information which are recorded at a second radial position of the disk, when the head is controlled to be positioned at the first radial position on the disk.

### CROSS-REFERENCE TO RELATED APPLICATIONS

This application claims the benefit of U.S. Provisional Application No. 61/981,100, filed Apr. 17, 2014, the entire contents of which are incorporated herein by reference.

### FIELD

Embodiments described herein relate generally to a data storage apparatus and a method for correcting a repeatable runout.

### BACKGROUND

In a disk storage apparatus (disk drive) as typified by a hard disk drive (HDD), data is written to a track which is a recording area on a disk or read from the track by a magnetic head (hereinafter referred to simply as a head). In this case, a controller of the HDD executes servo control so as to position the head at a target radial position. The servo control is executed by using a servo frame recorded on the disk.

The servo frame is comprised of an address which discretely indicates a radial position and a circumferential position, a servo burst for detecting a continuous radial position variation, and a postcode for correcting a repeatable runout (RRO). Generally, the RRO at each radial position is measured and a postcode is recorded based on the measured RRO after servo writing of all the addresses and the servo bursts is completed. In subsequent tracking, the RRO can be reduced by executing feedforward control using RRO correction information recorded in the postcode.

One of the low-order causes of an RRO may be a non-repeatable runout (NRRO) at first recording of the addresses and the servo bursts. A high-order cause of an RRO is occupied by sensor noise caused by the magnetic recording and reading noise of a servo burst module. Since the former is relatively increased by narrowing track pitches in recent years and the latter tends to be increased by higher recording density, a postcode and a method of positioning by using the postcode are widely used.

### BRIEF DESCRIPTION OF THE DRAWINGS

FIG. 1 is an exemplary block diagram showing a configuration of a disk drive of an embodiment;

FIG. 2 is an exemplary diagram showing a configuration of a servo frame of the embodiment;

FIG. 3 is an exemplary flowchart showing a process of writing RRO correction information and RRO variation information of the embodiment;

FIG. 4 is an exemplary flowchart showing procedure of executing RRO feedforward correction at recording and reading of the embodiment; and

FIG. 5 is a flowchart showing procedure of executing the RRO feedforward correction at recording and reading of the embodiment.

### DETAILED DESCRIPTION

In general, according to one embodiment, a data storage apparatus includes a disk, a head and a controller. The disk is configured to be recorded a plurality of correction information corresponding to a plurality of radial positions of the disk and a plurality of variation information corresponding to the plurality of correction information. Each of the correction information is information for correcting a repeatable runout at each of the radial positions. Each of the variation information is information corresponding to a variation amount of a repeatable runout at a radial direction of the disk at each of the radial positions. The head is configured to write data to the disk or to read data from the disk. The controller is configured to correct a first repeatable runout at a first radial position by using a first correction information of the plurality of correction information and a first variation information corresponding to the first correction information of the plurality of variation information, which are recorded at a second radial position of the disk, when the head is controlled to be positioned at the first radial position on the disk.

[Configuration of Disk Drive]

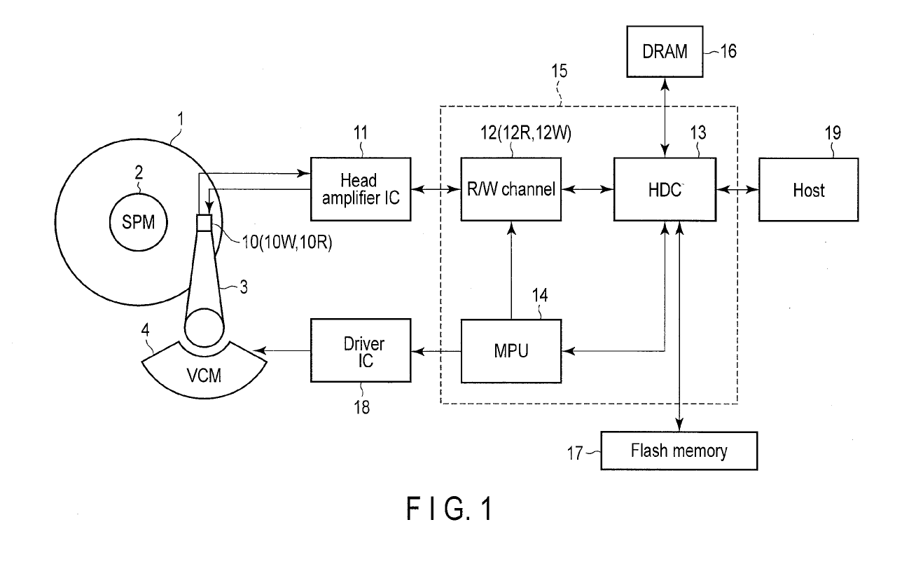

FIG. 1 is a block diagram showing main components of a hard disk drive (hereinafter referred to as “disk drive”) as a data storage apparatus of a present embodiment.

As shown in FIG. 1, the disk drive is configured to include a head-disk assembly (HDA), a head amplifier integrated circuit (hereinafter referred to as “head amplifier IC”) 11, a controller 15, and a driver IC 18. The HDA comprises a disk 1 serving as a storage medium, a spindle motor (SPM) 2, an arm 3 equipped with a head 10, and a voice coil motor (VCM) 4. The disk 1 is rotated by the spindle motor 2. An actuator is composed of the arm 3 and the VCM 4 and seeks the head 10 to a target position on the disk 1. That is, the actuator seeks the head 10 mounted on the arm 3 in a radial direction on the disk 1 by driving the VCM 4. Driving the VCM 4 is controlled by a driving current from the driver IC 18.

A number of tracks in which data is recorded are formed on the disk 1. The head 10 has a slider as a main body, and comprises a write head 10W and a read head 10R mounted on the slider. The read head 10R reads data recorded in each track on the disk 1. The read data is servo information and user data, which will be described later. The write head 10W writes the user data on the disk 1. At least two heads 10 are mounted, and write data to or read data from both sides of the single disk 1.

The head amplifier IC 11 comprises a read amplifier and a write driver. The read amplifier amplifies a read signal read by the read head 10R and transmits the amplified signal to a read/write (R/W) channel 12. Meanwhile, the right driver transmits a write current depending on write data, which is output from the R/W channel 12, to the write head 10W.

The controller 15 is comprised of a single IC chip including the R/W channel 12, a hard disk controller (HDC) 13 and a microprocessor (MPU) 14. The R/W channel 12 includes a read channel 12R and a write channel 12W. The read channel 12R processes the read signal read by the read head 10R and decodes data (including the servo information). The write channel 12W executes signal processing of the write data from the HDC 13.

The HDC 13 controls data transfer between a host 19 and the R/W channel 12. The HDC 13 executes data transfer control by controlling a buffer memory (DRAM) 16 and temporarily recording the read data and the write data in the buffer memory 16. In addition, the HDC 13 controls a flash memory 17 and use the memory as, for example, a cache area in which data is temporarily recorded.

The MPU 14 is sometimes called a microcontroller. The MPU 14 controls the VCM 4 via the driver IC 18 and executes positioning control (servo control) of the head 10. Furthermore, the MPU 14 controls recording and reading of the data via the R/W channel 12.

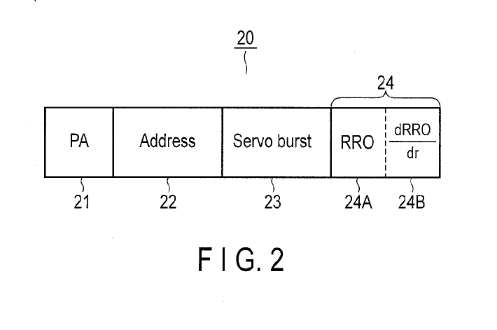

As shown in FIG. 2, a servo frame 20 is provided in each track formed on the disk 1. The servo information necessary for the servo control is recorded in the servo frame 20. The servo frame 20 comprises areas 21 to 24 in which a preamble (PA), addresses (a track address and a sector address), a servo burst, repeatable runout (RRO) correction information, and RRO variation information as included in the servo information are recorded, respectively.

The controller 15 executes learning processing to remove the influence of RRO by using a position error calculation result based on the servo burst read by the read head 10R. That is, the controller 15 calculates the RRO correction information by the learning processing. It should be noted that the RRO correction information is calculated from a position error at the servo control by using reverse characteristics of position error compression characteristics by the servo control.

In the present embodiment, the area 24 in which the RRO correction information and the RRO variation information are recorded is called “postcode area”. The postcode area 24 is divided into an area 24A in which the RRO correction information is recorded and an area 24B in which the RRO variation information is recorded. The RRO correction information is data composed of a Manchester code calculated by the learning processing (measuring processing). The RRO variation information is information corresponding to a variation amount of a repeatable runout in the radial direction of the disk 1. For example, the RRO variation information is a variation rate of a repeatable runout per unit length in the radial direction. In this case, the RRO variation information is represented by dRRO/dr. It should be noted that the RRO correction information is recorded but the RRO variation information is not recorded in a conventional postcode area.

In a case where a postcode is recorded in a radial cycle rₛ between a postcode recording start radial position rᵢ and a postcode recording end radial position rₑ, since the RRO variation information is recorded in addition to the RRO correction information, continuous feedforward control for correcting an RRO can be executed even at a radial position rⱼ+x/rₛ (x<rₛ, j is a positive integer, and rᵢ≦rⱼ<r) at which a postcode is not recorded.

More specifically, RRO(rⱼ+x/rₛ) at the radial position rⱼ+x/rₛ (x<rₛ) can be calculated by equation (1). As a result, the RRO feedforward correction control using RRO(rⱼ+x/rₛ) at an arbitrary position (rⱼ+x/rₛ) can be executed.

$$RRO ( {r}_{j} + \frac{x}{{r}_{s}} ) = RRO ( {r}_{j} ) + \frac{x}{{r}_{s}} \times \frac{d RRO ( {r}_{j} )}{d r} \qquad ( 1 )$$

[Postcode Recording Processing]

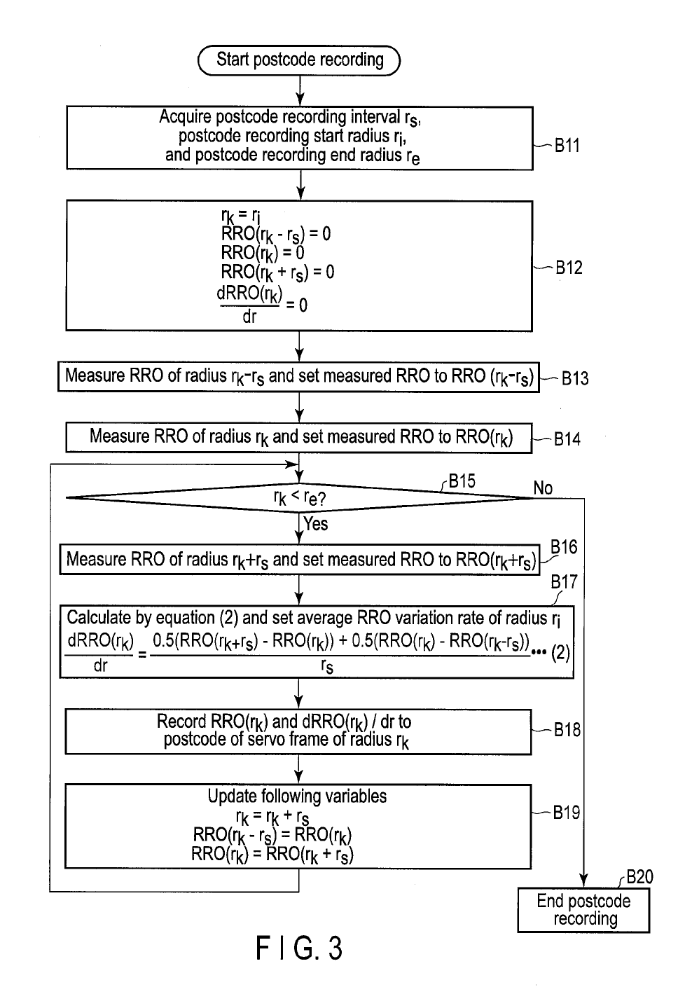

FIG. 3 is a flowchart showing an example of steps of processing to record a postcode.

The controller 15 obtains a postcode recording radial cycle rₛ, a postcode recording start radial position rᵢ and a postcode recording end radial position rₑ from, for example, the flash memory 17 (block B11). The controller 15 sets the postcode recording start radial position at the postcode recording radial position rₖ, and sets zero to variables in the processing, i.e., RRO(rₖ−rₛ), RRO(rₖ), RRO(rₖ+rₛ), and dRRO(rₖ)/dr (block B12).

The controller 15 measures the RRO at the postcode recording radial position rₖ−rₛ and sets the measured RRO to RRO(rₖ−rₛ) (block B13). The controller 15 measures the RRO at the postcode recording radial position rₖ and sets the measured RRO to RRO(rₖ) (block B14).

The controller 15 determines whether the radial position rₖ is smaller than the postcode recording end radial position rₑ (block B15). If the radial position rₖ is determined to be smaller than the postcode recording end radial position rₑ (Yes in block B15), the controller 15 measures the RRO in the radial position rₖ+rₛ and sets the measured RRO to the RRO(rₖ+rₛ) (block B16).

The controller 15 calculates an average RRO variation rate of the radial position rₖ (dRRO(rₖ)/dr) by equation (2) and sets the calculated variation rate to dRRO(rₖ)/dr of the radial position rₖ (block B17).

$$\frac{d RRO ( {r}_{k} )}{d r} = \frac{0.5 ( RRO ( {r}_{k} + {r}_{s} ) - RRO ( {r}_{k} ) ) + 0.5 ( RRO ( {r}_{k} ) - RRO ( {r}_{k} - {r}_{s} ) )}{{r}_{s}} \qquad ( 2 )$$

If the postcode recording radial position rₖ is the postcode recording start position rᵢ, the block B13 is skipped and the RRO variation information dRRO(rₖ)/dr is calculated by using equation (2′) instead of equation (2).

$$\frac{d RRO ( {r}_{k} )}{d r} = \frac{RRO ( {r}_{k} + {r}_{s} ) - RRO ( {r}_{k} )}{{r}_{s}} \qquad {( 2 )}^{′}$$

If the postcode recording radial position rₖ is the postcode recording end position rₑ, the block B15 is skipped and the RRO variation information dRRO(rₖ)/dr is calculated by using equation (2″) instead of equation (2).

$$\frac{d RRO ( {r}_{k} )}{d r} = \frac{RRO ( {r}_{k} ) - RRO ( {r}_{k} + {r}_{s} )}{{r}_{s}} \qquad {( 2 )}^{″}$$

The controller 15 records RRO(rₖ) and dRRO(rₖ)/dr in the postcode in the servo frame at the radial position rₖ (block B18). The controller 15 sets rₖ+rₛ to rₖ, sets RRO(rₖ) to RRO(rₖ-rₛ) and sets RRO(rₖ+rₛ) to RRO(rₖ) (block B19). Then, the controller 15 sequentially executes the processing from block B15.

In contrast, if the postcode recording radial position rₖ is determined not to be smaller than the postcode recording end radial position rₑ in block B15 (No in block B15), the controller 15 ends the postcode recording processing (block B20).

The embodiment is not limited to this, and it is possible to calculate the RRO variation information from RRO(r₁), RRO(r₂), . . . , RRO(rₓ) of an arbitrary number x equal to or greater than two of the radial positions. In addition, dRRO/dr is a first derivation of the RRO variation in the radial direction, but can also include a second derivation d²RRO/d²r or higher-order derivation of the RRO variation. The second derivation of the RRO variation indicates a variation rate of the first derivation amount of the RRO variation in the radial direction per unit length.

[Data Reading/Writing Operation]

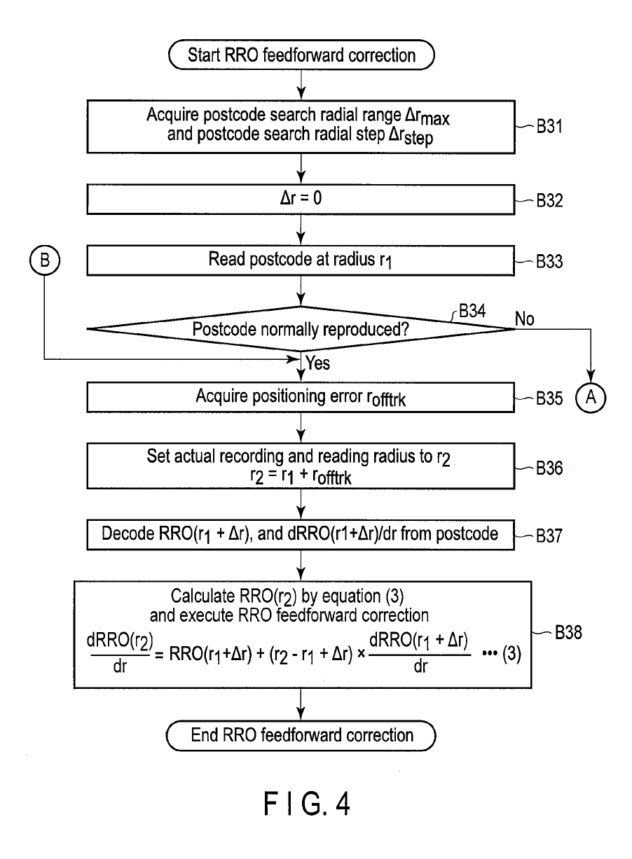

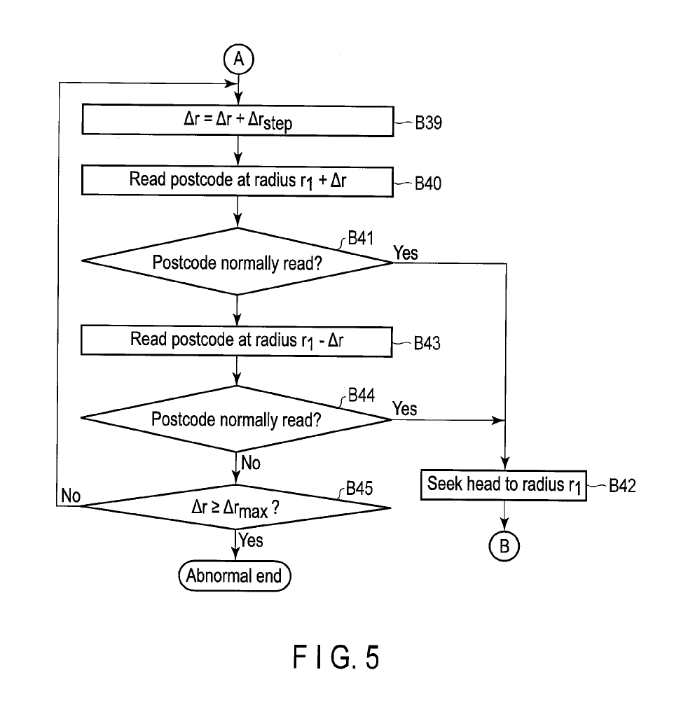

An example of executing RRO feedforward correction at recording and reading by using the postcode recorded on the disk will be described. The example of correction is shown in FIG. 4 and FIG. 5.

First, the controller 15 acquires a postcode search radial range Δrₘₐₓ and a postcode search radial step Δrₛₜₑₚ from, for example, the flash memory 17 (block B31). It should be noted that Δrₘₐₓ is approximately a write cycle of the postcode in the radial direction (postcode recording interval rₛ), and Δrₛₜₑₚ is equal to or less than Δrₘₐₓ. If recording or reading of data at a target recording and reading radial position r₁ is required, the controller 15 sets zero to Δr (block B32).

The controller 15 attempts to reading the postcode of the radial position r₁ (block B33), and determines whether the postcode has been normally read (block B34).

If the postcode is determined to have been normally read (Yes in block B34), the controller 15 calculates a positioning error r_{offtrk} between the target radial position r₁ and an actual radial position (block B35). The positioning error r_{offtrk} is caused by disturbance, etc. The controller 15 sets r₁+r_{offtrk} to r₂ (block B36), r₂ being the actual recording and reading radial position of the head. The controller 15 decodes RRO(r₁+Δr) and dRRO(r₁+Δr)/dr from the postcode recorded at the radial position r₁+Δr (block B37). The controller 15 calculates RRO(r₂) by equation (3) and executes the RRO feedforward correction (block B38). Then the RRO feedforward correction processing is ended.

$$\frac{d RRO ( {r}_{2} )}{d r} = RRO ( {r}_{1} + Δ r ) + ( {r}_{2} - {r}_{1} + Δ r ) \times \frac{d RRO ( {r}_{1} + Δ r )}{d r} \qquad ( 3 )$$

In contrast, if the postcode is not determined to have been normally read (No in block B34), the controller 15 sets a value of Δr+Δrₛₜₑₚ to a value of Δr (block B39). The controller 15 attempts to read the postcode at the radial position r₁+Δr (block B40). The controller 15 determines whether the postcode has been normally read (block B41). If the postcode is determined to have been normally read (Yes in block B41), the controller 15 seeks the head 10 to the radial position r₁ (block B42). Then, the controller 15 sequentially executes the processing from block B35.

If the postcode is determined not to have been normally read (No in block B41), the controller 15 attempts to read the postcode of the radial position r₁−Δr (block B43). The controller 15 determines whether the postcode have been normally read (block B44). If the postcode is determined to have been normally read (Yes in block B44), the controller 15 seeks the head 10 to the radial position r₁ (block B42). Then, the controller 15 sequentially executes the processing from block B35.

If the postcode is determined not to have been normally read (No in block B44), the controller 15 determines whether the value of Δr exceeds the value of Δrₘₐₓ (block B45). If the value of Δr is determined not to exceed the value of Δrₘₐₓ (No in block B44), the controller 15 sequentially executes the processing from block B39. If the value of Δr is determined to exceed the value of Δrₘₐₓ (Yes in block B45), the controller 15 abandons the execution of the RRO feedforward correction and abnormally ends the processing. A general abnormal end results in termination of recording and reading.

As described above, according to the present embodiment, positioning control to a target track on the disk on which a plurality of correction information corresponding to a plurality of radial positions and correcting repeatable runouts and a plurality of variation information corresponding to the plurality of correction information and indicating variation information of a repeatable runout at each radial position in the radial direction are recorded can be executed. In this case, the RRO at an arbitrary radial position can be calculated by using a first correction information of the correction information and a second variation information of the variation information corresponding to the first correction information. As a result, the RRO at the arbitrary radial position can be corrected.

In addition, the postcode of the present embodiment can be recorded even before a recording and reading radius, i.e., a physical format is defined. Since the postcode can be preliminarily recorded at various adjustments for defining a physical format, the RRO feedforward correction control can be executed by the postcode.

Furthermore, in a current apparatus in which a reading element and a recording element are generally separately arranged on a head, a relative relationship between a reading element orbit at data writing and a reading element orbit at data reading is continuously varied in the radial direction. Since the RRO feedforward correction following the continuous variation can be executed by using the postcode of the present embodiment, a postcode of one system is sufficient.

As regards the added information increment of the variation information to postcodes, postcodes in an HDD apparatus of recent years which has a higher recording density are arranged in a zigzag with respect to each of radial positions of two series, i.e., a recording radial position and a reading radial position. Since the zigzag alignment with respect to a radial position of a single series is sufficient, the design to absorb the postcode increment which causes the format loss can be achieved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A data storage apparatus comprising:
a disk configured store a plurality of correction information corresponding to a plurality of radial positions of the disk and a plurality of variation information corresponding to the plurality of correction information, each of the plurality of correction information comprising information for correcting a repeatable runout at each of the radial positions, and each of the plurality of variation information comprising information corresponding to a variation amount of a repeatable runout at a radial direction of the disk at each of the radial positions;
a head configured to write data to the disk or to read data from the disk; and
a controller configured to correct a first repeatable runout at a first radial position by using a first correction information of the plurality of correction information and a first variation information corresponding to the first correction information of the plurality of variation information, which are stored at a second radial position of the disk, when the head is to be positioned at the first radial position on the disk.

2. The apparatus of claim 1, wherein the controller is configured
to attempt to read a second correction information and a second variation information which are stored at a third radial position different from the second radial position on the disk, when reading of the first correction information and the first variation information has been unsuccessful,
to calculate a third correction information at the first radial position by using the second correction information and the second variation information, when reading of the second correction information and the second variation information has been successful, and
to correct the first repeatable runout by using the third correction information.

3. The apparatus of claim 1, wherein the controller is configured
to measure two or more repeatable runouts at two or more radial positions on the disk, the two or more radial positions comprising the second radial position,
to calculate a second variation information at the second radial position by using the two or more repeatable runouts, and
to write the second variation information to the second radial position on the disk.

4. The apparatus of claim 3, wherein
the disk comprises tracks which comprise data recording areas,
the tracks are provided at the radial direction, and
the two or more radial positions are different from a radial position at which the tracks are arranged.

5. A method of correcting a repeatable runout in a data storage apparatus, the apparatus comprising a disk and a head configured to write data to the disk or to read data from the disk, the disk storing a plurality of correction information corresponding to a plurality of radial positions of the disk and a plurality of variation information corresponding to the plurality of correction information, each of the plurality of correction information comprising information for correcting a repeatable runout at each of the radial positions, each of the plurality of variation information comprising information corresponding to a variation amount of a repeatable runout at a radial direction of the disk at each of the radial positions, the method comprising:
correcting a first repeatable runout at a first radial position by using a first correction information of the plurality of correction information and a first variation information corresponding to the first correction information of the plurality of variation information, which are stored at a second radial position of the disk, when the head is to be positioned at the first radial position on the disk.

6. The method of claim 5, further comprising:
attempting to read a second correction information and a second variation information which are stored at a third radial position different from the second radial position on the disk, when reading of the first correction information and the first variation information has been unsuccessful,
calculating a third correction information at the first radial position by using the second correction information and the second variation information, when reading of the second correction information and the second variation information has been successful, and
correcting the first repeatable runout by using the third correction information.

7. A method of writing information in a data storage apparatus, the apparatus comprising a disk and a head configured to write data to the disk or read data from the disk, the method comprising:
measuring two or more repeatable runouts at two or more radial positions on the disk, the two or more radial positions comprising a first radial position,
calculating a first variation information indicating a variation rate of a first repeatable runout at the first radial position in a radial direction by using the two or more repeatable runouts, and
writing the first variation information to the first radial position on the disk.

8. The apparatus of claim 1, wherein the plurality of variation information comprise a variation rate of the plurality of correction information per unit length in the radial direction.

9. The method of claim 5, wherein the plurality of variation information comprise a variation rate of the plurality of correction information per unit length in the radial direction.

10. The method of claim 7, wherein the first variation information comprises a variation rate of the first repeatable runout per unit length in the radial direction.

11. The method of claim 5, further comprising:
measuring two or more repeatable runouts at two or more radial positions on the disk, the two or more radial positions comprising the second radial position,
calculating a second variation information at the second radial position by using the two or more repeatable runouts, and
writing the second variation information to the second radial position on the disk.

12. The method of claim 11, wherein measuring the two or more repeatable runouts at two or more radial positions comprises:
measuring the two or more repeatable runouts at two or more radial positions which are different from a radial position at which tracks are arranged wherein the disk comprises the tracks which comprise data recording areas, and the tracks are provided at the radial direction.
